(19) United States
(12) Patent Application Publication
(10) Pub. No.: US 2018/0099569 A1
(43) Pub. Date: Apr. 12, 2018

(54) POWER TRANSMISSION APPARATUS

(71) Applicant: HONDA MOTOR CO., LTD., Tokyo (JP)

(72) Inventors: Takuya Iwamoto, Wako-shi (JP); Tomoaki Nakagawa, Wako-shi (JP)

(73) Assignee: HONDA MOTOR CO., LTD., Tokyo (JP)

(21) Appl. No.: 15/728,886

(22) Filed: Oct. 10, 2017

(30) Foreign Application Priority Data
Oct. 11, 2016 (JP) 2016-200172

(51) Int. Cl. B60L 11/18; H01F 38/14; H02J 50/12

(52) U.S. Cl. CPC B60L 11/182; H02J 50/12; H01F 38/14; B60L 11/1824

(57) ABSTRACT

A power transmission apparatus includes a power transmitting unit which is disposed on a plane defined by a front-rear direction and a left-right direction which are at right angles to each other, which transmits power in a non-contact manner to a power receiving unit installed on a vehicle which enables to move on the plane, and a housing which accommodates the power transmitting unit, which is larger by a first specified amount in four directions than the power transmitting unit when the plane is seen from thereabove, and which projects vertically from the plane. In the case where the power receiving unit is positioned to be included in the housing when the plane is seen from thereabove, the first specified amount is a value which satisfies at least one of conditions that a power transmission efficiency between the power transmitting unit and the power receiving unit are equal to or greater than a predetermined amount, and that a leakage magnetic field strength is smaller than a predetermined amount.

### CROSS REFERENCE TO RELATED APPLICATIONS

This application is based on Japanese Patent Application (No. 2016-200172) filed on Oct. 11, 2016, the contents of which are incorporated herein by reference.

### TECHNICAL FIELD

The present invention relates to a power transmission apparatus utilizing a non-contact power transmission technology.

### BACKGROUND ART

Patent literature 1 describes the non-contact charging facility which can ensure an accurate positioning of the non-contact power transmitting unit in relation to the non-contact power receiving unit. In the non-contact charging facility, since the position of the vehicle which incorporates therein the non-contact power receiving unit relative to the non-contact power transmitting unit in the base member is controlled by the chock members in relation to the front-rear direction of the vehicle, when parking the vehicle, the relative position of the non-contact power receiving unit to the non-contact power transmitting unit in relation to the front-rear direction of the vehicle becomes constant at all times.

### RELATED ART LITERATURE

### Patent Literature

Patent Literature 1: JP-A-2015-119510

Patent Literature 2: JP-B-5270015

### SUMMARY OF THE INVENTION

### Problem that the Invention is to Solve

In the non-contact charging facility of patent literature 1 described above, the accurate positioning of the non-contact power receiving unit relative to the non-contact power transmitting unit in relation to the front-rear direction of the vehicle can be ensured by the chock members. However, the relative positional relationship between the non-contact power receiving unit and the non-contact power transmitting unit in the vehicle's width direction is not controlled, and therefore, an accurate positioning of the non-contact power receiving unit relative to the non-contact power transmitting unit in relation to the vehicle's width direction cannot be ensured. Even though the vehicle can be positioned accurately in relation to the front-rear direction thereof, in the event that a positional deviation is present in relation to the vehicle's width direction, there may be a case where the power transmission efficiency and the leakage magnetic field strength between the non-contact power transmitting unit and the non-contact power receiving unit do not satisfy the desired conditions. Therefore, the position of the vehicle in relation to the vehicle's width direction also becomes important.

In the non-contact charging facility described of patent literature 1, since the non-contact power transmitting unit is embedded in the base member, the driver of the vehicle cannot grasp visually the target parking position. In the feeding system of patent literature 2, the non-contact power transmitting unit is used which is partially inclined in shape. However, even in the event that the non-contact power transmitting unit is used, since the non-contact power transmitting unit is not so shaped in consideration of the alignment of the vehicle including the non-contact power receiving unit with the non-contact power transmitting unit, the non-contact power transmitting unit described therein does not contribute to an accurate positioning of the vehicle or the non-contact power receiving unit relative to the non-contact power transmitting unit.

An object of the invention is to provide a power transmission apparatus which allows a driver of a vehicle to align the vehicle with a parking position intuitively when parking the vehicle in the parking position.

### Means for Solving the Problem

With a view to achieving the object described above, according to an invention of (1), there is provided a power transmission apparatus including:

a power transmitting unit (for example, a primary coil 101 in an embodiment) which is disposed on a plane defined by a front-rear direction and a left-right direction which are at right angles to each other, which transmits power in a non-contact manner to a power receiving unit (for example, a secondary coil 12 in the an embodiment) installed in a vehicle (for example, an electric vehicle 11 in an embodiment) which enables to move on the plane; and

a housing (for example, a housing 103 in an embodiment) which accommodates the power transmitting unit, which is larger by a first specified amount (for example, a first specified amount x1 in an embodiment) in four directions than the power transmitting unit when the plane is seen from thereabove, and which projects vertically from the plane,

wherein in a case where the power receiving unit is positioned to be included in the housing when the plane is seen from thereabove, the first specified amount is a value which satisfies at least one of conditions that a power transmitting efficiency between the power transmitting unit and the power receiving unit is equal to or greater than a predetermined value, and that a leakage magnetic filed strength is smaller than a predetermined value.

According to an invention of (2), in the invention of (1),

wherein when the plane is seen from thereabove, the housing has an edge portion (for example, an edge portion 103e in an embodiment) which extends radially outwards by a second specified amount (for example, a second specified amount x2 in an embodiment) from at least part of an outer circumference which lies by the first specified amount away from an outer circumference of the power transmitting unit in four directions.

According to an invention of (3), in the invention of (2),

wherein the second specified amount is equal to or smaller than 10 cm.

According to an invention of (4), in the invention of (2),

wherein a vertical shape of the edge portion differs from a vertical shape of the power transmitting unit.

According to an invention of (5), in the invention of (4),

wherein the edge portion is shaped that at least an end portion is rounded.

According to an invention of (6), in the invention of (5),

wherein the edge portion is shaped that at least an end portion is tapered.

According to an invention of (7), there is provided a power transmission apparatus including:

a power transmitting unit (for example, the primary coil 101 in an embodiment) which is disposed on a plane defined by a front-rear direction and a left-right direction which are at right angles to each other, which transmits power in a non-contact manner to a power receiving unit (for example, the secondary coil 12 in an embodiment) installed in a vehicle (for example, the electric vehicle 11 in an embodiment) which enables to move on the plane; and

a housing (for example, a housing 103 in an embodiment) which accommodates the power transmitting unit, which is larger by a first specified amount (for example, the first specified amount x1 in an embodiment) in the left-right direction than the power transmitting unit when the plane is seen from thereabove, and which projects vertically from the plane,

wherein in a case where the power receiving unit is positioned to be included in the housing in the left-right direction when the plane is seen from thereabove, the first specified amount is a value which enables to satisfy at least one of conditions that a power transmitting efficiency between the power transmitting unit and the power receiving unit is equal to or greater than a predetermined value, and that a leakage magnetic filed strength is smaller than a predetermined value, and

the left-right direction is a direction which is substantially at right angles to a traveling direction of the vehicle while following the plane.

According to an invention of (8), in the invention of (7),

wherein when the plane is seen from thereabove, the housing has an edge portion (for example, the edge portion 103e in an embodiment) which extends radially outwards by a second specified amount (for example, the second specified amount x2 in an embodiment) from at least part of left and right outer circumferences of the housing which lie by the first specified amount away from an outer circumference of the power transmitting unit in the left-right direction, and front and rear outer circumferences of the power transmitting unit in the front-rear direction.

According to an invention of (9), in the invention of (7),

wherein when the plane is seen from thereabove, the housing has an edge portion (for example, the edge portion 103e in an embodiment) which extends radially outwards by a second specified amount (for example, the second specified amount x2 in an embodiment) from left and right outer circumferences of the housing which lie by the first specified amount away from an outer circumference of the power transmitting unit in the left-right direction.

### Advantages of the Invention

According to the invention of (1), the housing which accommodates the power transmitting unit projects vertically from the plane, and when the plane is seen from thereabove, the housing has the size which is larger by the first specified amount in the four directions than the power transmitting unit. In a case where the power receiving unit is positioned to be included in the housing when the plane is seen from thereabove, the first specified amount is the value which satisfies at least one of the conditions that the power transmitting efficiency is equal to or greater than the predetermined value, and that the leakage magnetic filed strength is smaller than the predetermined value, and the first specified amount constitutes a maximum amount (a positional deviation permitting amount) which permits a positional deviation of the power receiving unit relative to the power transmitting unit. Due to this, with the vehicle given such a tread (a distance between wheels) that a wheel thereof rides on the housing in a case where the power receiving unit is not included in the housing when the plane is seen from thereabove, in a case where the wheel rides on the housing, a driver of the vehicle can sense from a loss of the balance of the vehicle caused by the wheel riding on the housing that the power transmission efficiency and the leakage magnetic field strength both do not satisfy the desired conditions due to a positional deviation in the left-right direction. Since the housing projects vertically from the plane, the driver of the vehicle can grasp visually the target parking position. In this way, in parking the vehicle in the parking position, the driver can accurately align the vehicle in relation to the left-right direction through intuition.

According to the invention of (2), since the edge portion which extends by the second specified amount is provided at least part of the outer circumference of the housing, the driver of the vehicle can grasp in advance the occurrence of positional deviation from the fact that the wheel rides on the housing.

When the second specified amount which constitutes the radial dimension of the edge portion is too great, even though an occurring positional deviation is small, the wheel of the vehicle rides on the housing, whereas when the second specified amount is too small, the driver cannot grasp the occurring positional deviation. According to the invention of (3), since the second specified amount is equal to or smaller than 10 cm, the driver can grasp the occurring positional deviation in advance appropriately.

According to the invention of (4), since the vertical shape of the edge portion differs from the shape of the power transmitting unit, due to the improved visibility of the housing from the shape thereof, the driver of the vehicle can grasp visually the target parking position.

According to the invention of (5), since the end portion of the edge portion has the rounded shape, the wheel of the vehicle easily rides on the housing, whereby the driver of the vehicle can grasp in advance and accurately the occurrence of a positional deviation of the vehicle which is triggered by the fact that the wheel rides on the housing.

According to the invention of (6), since the end portion of the edge portion has the tapered shape, the wheel of the vehicle easily rides on the housing, whereby the driver of the vehicle can grasp in advance and accurately the occurrence of a positional deviation of the vehicle which is triggered by the fact that the wheel rides on the housing.

According to the invention of (7), the housing which accommodates the power transmitting unit projects vertically from the plane, and when the plane is seen from thereabove, the housing has the size which is larger by the first specified amount in the left-right direction than the power transmitting unit. In a case where the power receiving unit is included in the housing in the left-right direction, when the plane is seen from thereabove, the first specified amount is the value which satisfies at least one of the conditions that the power transmitting efficiency is equal to or greater than the predetermined value and that the leakage magnetic filed strength is smaller than the predetermined value, and the first specified amount constitutes the maximum amount (the maximum positional deviation amount) which permits the positional deviation of the power receiving unit relative to the power transmitting unit. Due to this, with the vehicle given such a tread (a distance between wheels) that a wheel thereof rides on the housing in a case where the power receiving unit is not included in the housing when the plane is seen from thereabove, in a case where the wheel rides on the housing, a driver of the vehicle can sense from a loss of the balance of the vehicle caused by the wheel riding on the housing that the power transmission efficiency and the leakage magnetic field strength both do not satisfy the desired conditions due to the positional deviation in the left-right direction. Since the housing projects vertically from the plane, the driver of the vehicle can grasp visually the target parking position. In this way, in parking the vehicle in the parking position, the driver can accurately align the vehicle intuitively. Since the housing is larger in size by the first specified amount than the power transmitting unit only in the left-right direction, the housing remains in size the same as the power transmitting unit in the front-rear direction. This makes it possible to provide the power transmission apparatus which is larger in size only in the left-right direction which the driver has difficulty in grasping.

According to the invention of (8), since the edge portion which extends by the second specified amount is provided on at least part of the left and right outer circumferences and the front and rear outer circumferences of the housing, the driver of the vehicle can grasp in advance the occurrence of positional deviation of the vehicle from the fact that the wheel rides on the housing.

According to the invention of (9), since the edge portion which extends by the second specified amount is provided on the left and right outer circumferences of the housing, the driver of the vehicle can grasp in advance the occurrence of positional deviation of the vehicle from the fact that the wheel rides on the housing.

### BRIEF DESCRIPTION OF THE DRAWINGS

FIGS. 1A to 1C are plan views of an electric vehicle showing a change in position of the electric vehicle in parking it in a parking position where a power transmission apparatus is disposed without any positional deviation.

FIG. 2 is a rear view of the electric vehicle shown in FIGS. 1A to 1C.

FIGS. 3A to 3C are drawings showing sizes of primary coils corresponding to shapes thereof.

FIG. 4 is a drawing showing a relationship in size of a primary coil with a housing when it is seen from thereabove and a power transmission efficiency and a leakage magnetic field strength which correspond to a relative position of the primary coil to a secondary coil in an embodiment of the invention.

FIGS. 5A to 5C are plan views of the electric vehicle showing a change in position of the electric vehicle when parking it in the parking position in such a state that a left rear wheel rides on the housing of the power transmission apparatus due to the electric vehicle being parked so close to a right-hand side of the parking position as to exceed a positional deviation permitting amount.

FIG. 6 is a rear view of the electric vehicle shown in FIG. 5B.

FIGS. 7A to 7D are drawings showing a plurality of horizontal forms taken by the housing.

FIG. 8 is a drawing showing a relationship in size of a primary coil with a housing when it is seen from thereabove and a power transmission efficiency and a leakage magnetic field strength which correspond to a relative position of the primary coil to a secondary coil according to another embodiment.

FIGS. 9A to 9C are plan views of the electric vehicle showing a change in position of the electric vehicle when parking it in the parking position in such a state that a left rear wheel rides on the housing of the power transmission apparatus due to the electric vehicle being parked so close to a right-hand side of the parking position as to exceed a positional deviation permitting amount.

### MODE FOR CARRYING OUT THE INVENTION

Hereinafter, embodiments of the invention will be described by reference to the drawings. The drawings should be seen in a direction in which given reference numerals look normal. In the following description, front, rear, left, right, up and down denote, respectively, such directions as seen from a driver of a vehicle who sits in a driver's seat, and front, rear, left, right, up and down sides of the vehicle are denoted by Fr, Rr, L, R, U and D, respectively, in the drawings.

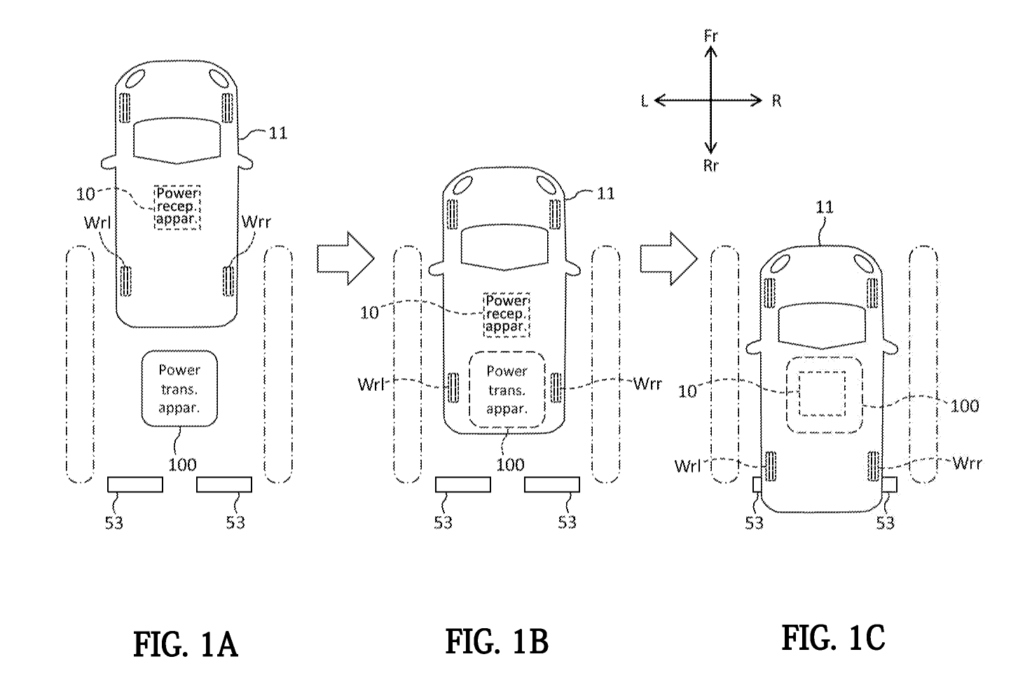

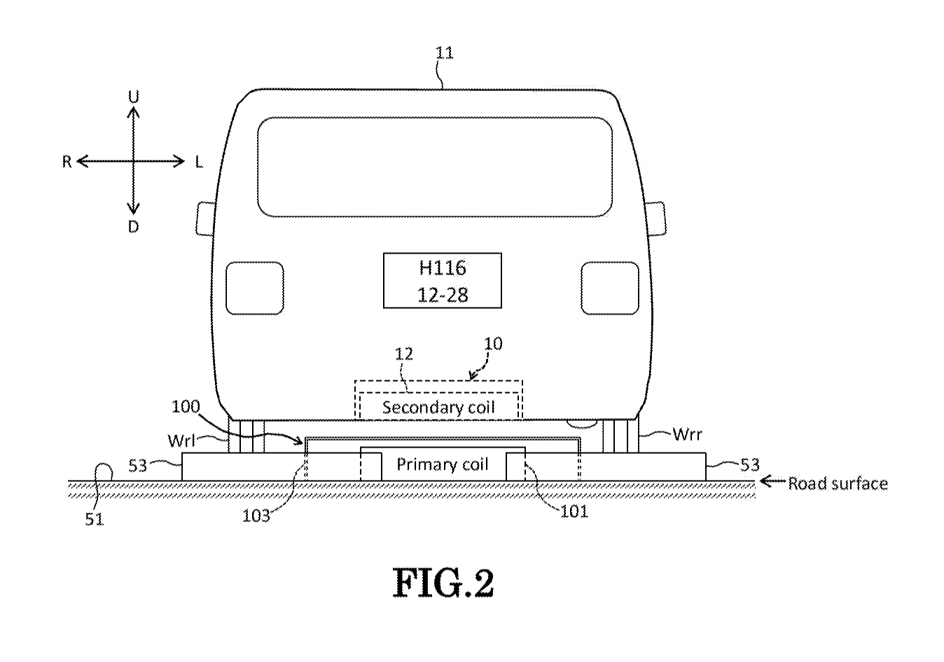

FIGS. 1A to 1C are plan views of an electric vehicle showing a change in position of the electric vehicle in parking it in a parking position where a power transmission apparatus is disposed without any positional deviation. FIG. 2 is a rear view of the electric vehicle shown in FIGS. 1A to 1C. As shown in FIGS. 1A, 1B, 1C and 2, a power transmission apparatus 100, which is disposed on a parking position for an electric vehicle 11 having a power reception apparatus 10 for receiving alternating-current powder in a non-contact manner, is disposed on a road surface or the like which makes up a parking facility and is connected to an external power system such as a commercial power supply or the like. As shown in FIGS. 1A to 1C, a driver of the electric vehicle 11 drives the electric vehicle 11 rearwards or forwards towards the power transmission apparatus 100 and stops the electric vehicle 11 in a position where the power reception apparatus 10 of the electric vehicle 11 faces the power transmission apparatus 100.

As shown in FIG. 2, the power transmission apparatus 100 has a primary coil 101 and a housing 103, and the power reception apparatus 10 of the electric vehicle 11 has a secondary coil 12. Because of this, when the primary coil 101 of the power transmission apparatus 100 is energized by alternating-current power obtained from the exterior power system with winding surfaces of the primary and secondary coils positioned close to each other, an electric current flows to the secondary coil 12 of the power reception apparatus 10 by the action of magnetic resonance. A battery of the electric vehicle 11 is charged (through non-contact charging) by way of a rectifier. The power transmission method of transmitting power from the power transmission apparatus 100 to the power reception apparatus 10 may adopts the magnetic resonance method described above or an electromagnetic induction method.

Since the power transmission apparatus 100 is disposed on the road surface or the like having a parking facility, the power transmission apparatus 100 is susceptible to stress from an exterior portion, as well as rain, wind, dust and the like. Because of this, the primary coil 101 possessed by the power transmission apparatus 100 is accommodated in an interior of a housing 103 which is provided so as to project vertically from a setting plane 51 where the power transmission apparatus 100 is set.

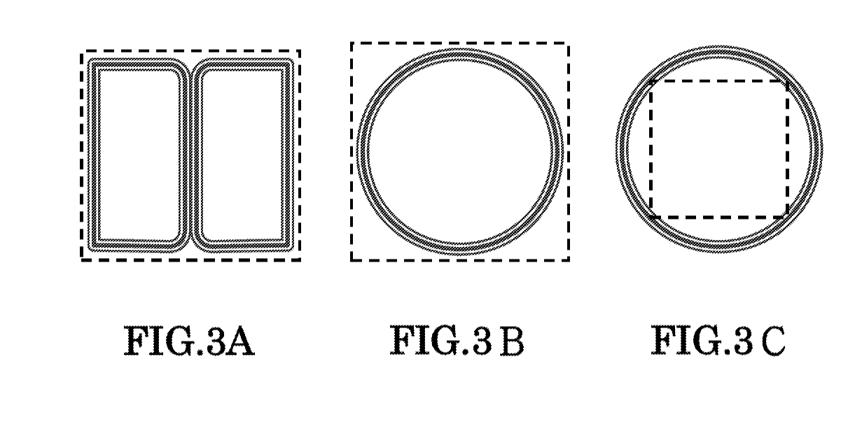

Hereinafter, a size of the housing 103 which accommodates the primary coil 101 resulting when it is seen from thereabove will be described. A size of the primary coil 101 is expressed by lengths of two sides of a rectangle which corresponds to a shape of the primary coil 101. For example, as shown in FIG. 3A, a size of a primary coil made up of two D-shaped coils which are arranged side by side so as to face each other is expressed by lengths of two sides of a rectangle indicted by dotted lines in FIG. 3A which surrounds or contacts the two coils. As shown in FIG. 3B, in a case where the primary coil 101 is circular, a size of the primary coil is expressed by lengths of two sides of a rectangle indicated by dotted lines in FIG. 3B which surrounds or contacts an outside diameter of the coil. As shown in FIG. 3C, in a case where the primary coil 101 is circular, a size of the primary coil may be expressed by lengths of two sides of a rectangle indicated by dotted lines in FIG. 3C which is surrounded or contacted by an inside diameter of the coil. As with the primary coil 101, a size of the secondary coil 12 is expressed by lengths of two sides of a rectangle corresponding to a shape of the secondary coil 12.

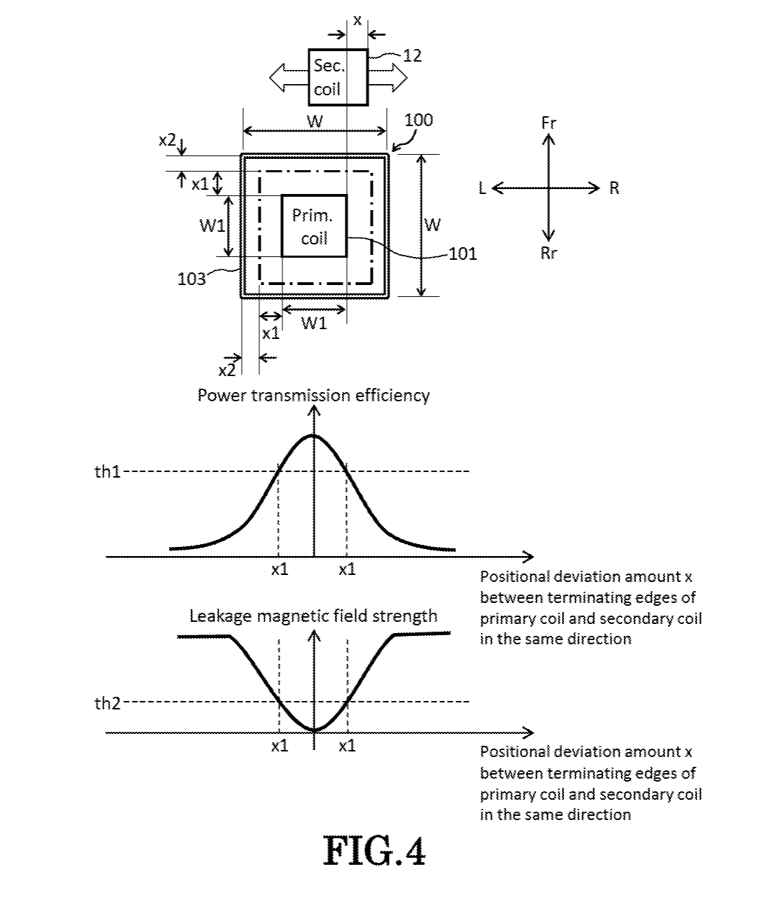

FIG. 4 is a drawing showing a relationship in size of the primary coil 101 with the housing 103 when it is seen from thereabove and a power transmission efficiency and a leakage magnetic field strength which correspond to a relative position of the primary coil 101 to the secondary coil 12. As shown in FIG. 4, a power transmission efficiency and a leakage magnetic field strength between the primary coil 101 and the secondary coil 12 change according to a positional deviation amount x of a terminating edge of the primary coil 101 from a terminating edge of the secondary coil 12 in the same direction when it is seen from thereabove. The positional deviation amount x shown in FIG. 4 is the deviation amount in a left-right direction. However, a relationship between a positional deviation amount between terminating edges of the primary coil 101 and the secondary coil 12 in the same direction in a front-rear direction and a power transmission efficiency and a leakage magnetic field strength will be the same as that in the left-right direction described above.

In this embodiment, a maximum positional deviation amount x which satisfies at least one of conditions that the power transmission efficiency is equal to or greater than a threshold th1 and that the leakage magnetic field strength is smaller than a threshold th2 is set at a first specified amount x1 which is a maximum amount (a positional deviation permitting amount) permitting a positional deviation of the power reception apparatus 10 relative to the power transmission apparatus 100. A size of the housing 103 when it is seen from thereabove corresponds to a size indicated by alternate long and short dash lines in FIG. 4 in which horizontal terminating edges of the housing 103 are expanded the first specified amount x1 or greater in four directions (the front-rear direction and the left-right direction) from four sides of the primary coil 101. In this embodiment, a size of the housing 103 is set at a size indicated by double lines in FIG. 4 in which the horizontal terminating edges of the housing 103 are expanded further by a second specified amount x2 in the four directions from the four sides of the housing 103 whose size is indicated by the alternate long and short dash lines in FIG. 4. The second specified amount x2 is a fixed value which is equal to or smaller than 10 cm and is preferably a fixed value of the order of 5 cm. Consequently, a length W of one of four sides of the housing 103 when it is seen from thereabove is expressed by the following expression (1). A length of one of four sides of the primary coil 101 is denoted by W1.

W=W1+2X(x1+x2) (1)

In this way, since the size of the housing 103 seen from thereabove is set as described above, in the case where the electric vehicle 11 including the power reception apparatus 10 is parked at the parking position where the power transmission apparatus 100 having the housing 103 is disposed, when the secondary coil 12 of the power reception apparatus 10 is positioned to be included in a positional deviation permitting zone (a zone indicated by alternate long and short dash lines in FIG. 4) within the housing 103 which is defined by the first specified amount x1 when it is seen from thereabove, at least one of the conditions that the power transmission efficiency is equal to or greater than the threshold th1, and that the leakage magnetic field strength is smaller than the threshold th2 is satisfied.

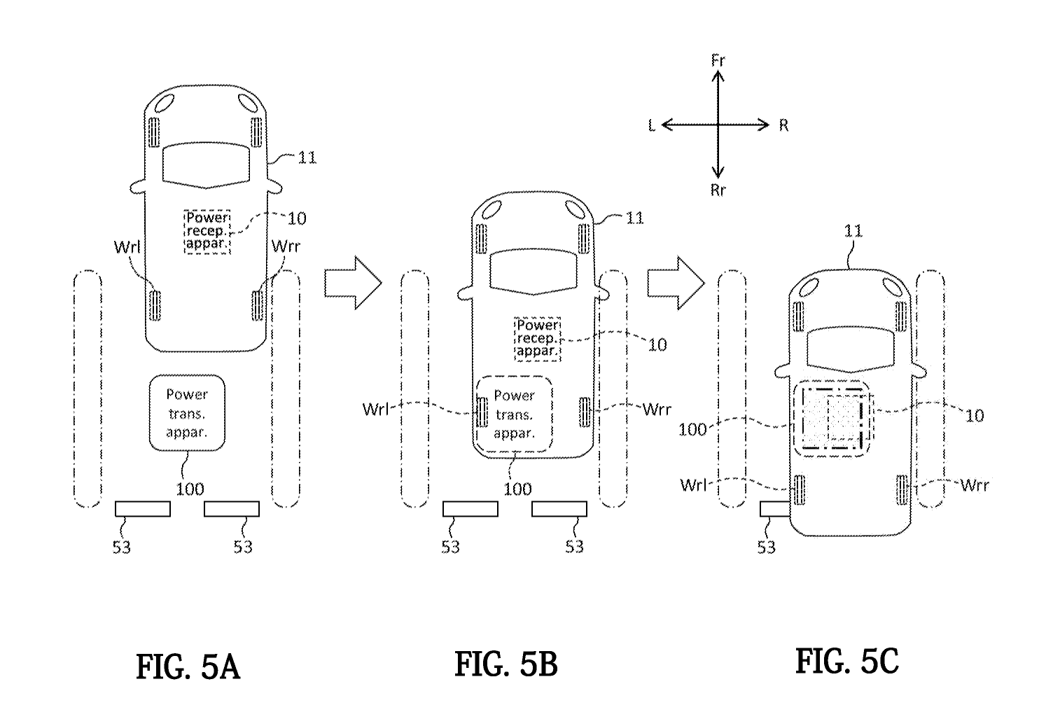

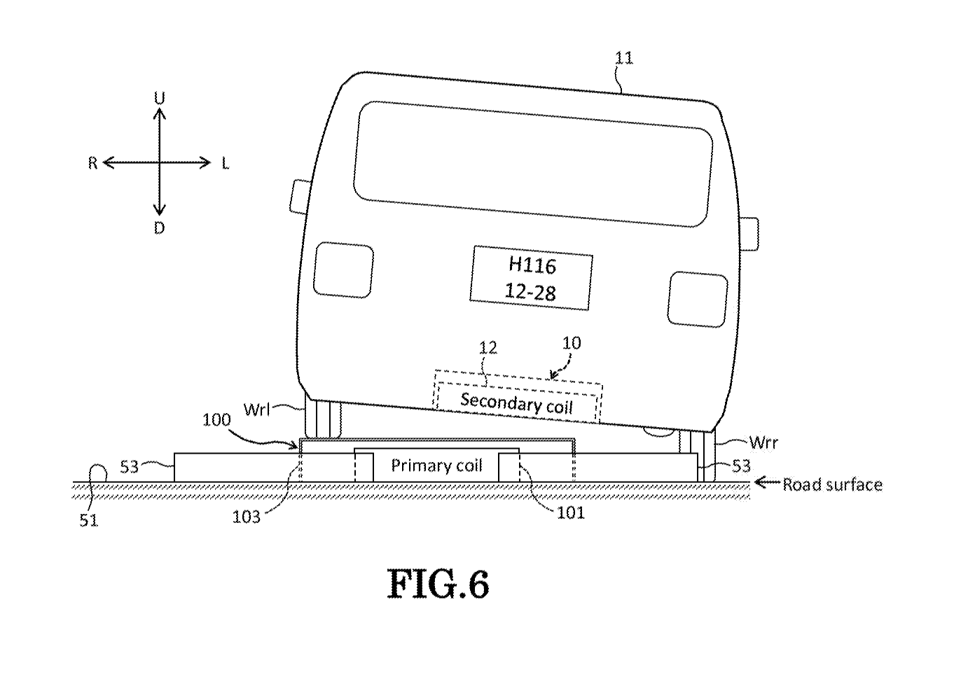

In addition, the housing 103 is made larger in size than the primary coil 101 when it is seen from thereabove, and with the electric vehicle 11 given such a tread (a distance between wheels) that a wheel thereof rides on the housing 103 in a case where the secondary coil 12 is not included in the positional deviation permitting zone of the housing 103 when it is seen from thereabove, when the wheel rides on the housing 103 as shown in FIGS. 5A, 5B, 5C and 6, a driver of the electric vehicle 11 can sense from a loss of the balance of the electric vehicle 11 caused by the wheel riding on the housing 103 that the power transmission efficiency and the leakage magnetic field strength both do not satisfy the desired conditions due to a positional deviation of the electric vehicle 11 in the left-right direction. The example shown in FIGS. 5A, 5B, 5C and 6 illustrates a case where in parking the electric vehicle 11 in the parking position, a left rear wheel Wrl rides on the housing 103 of the power transmission apparatus 100 since the electric vehicle 11 is parked so close to a right-hand side of the parking position as to surpass a positional deviation permitting amount.

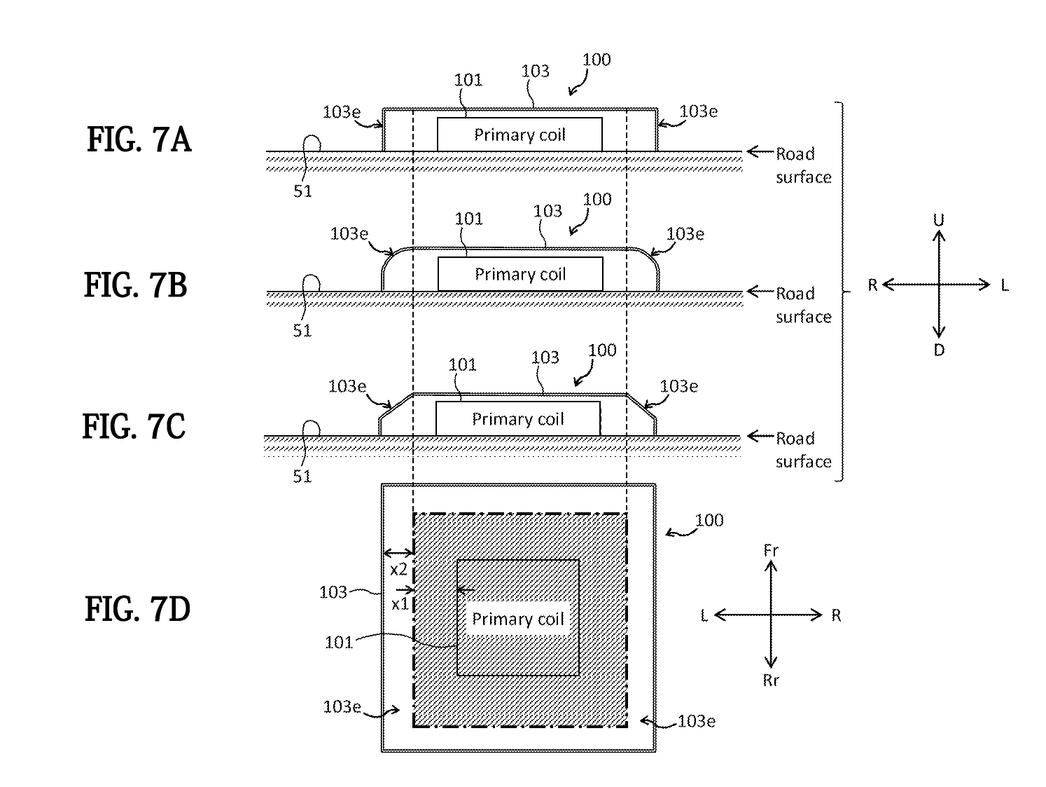

Next, referring to FIGS. 7A to 7D, horizontal forms that the housing 103 can take will be described. As described above, the housing 103 is provided so as to project vertically from the setting plane 51 of the power transmission apparatus 100 and accommodates the primary coil 101 in the interior thereof. Horizontal outer edges of the housing 103 are positioned by “the first specified amount x1+the second specified amount x2” away from an outer circumference of the primary coil 101 in the four directions. A positional deviation permitting zone shown hatched in FIG. 7D is provided inside the housing 103 to constitute an edge portion 103e which expands radially outwards by the second specified amount x2 from the positional deviation permitting zone of the housing 103. A vertical shape of the edge portion 103eresulting when seen from a horizontal direction is the same or different from a vertical shape of the primary coil 101. In an example shown in FIG. 7A, a vertical shape of the edge portion 103e is the same as that of the primary coil 101. In each example shown in FIGS. 7B and 7C, a vertical shape of the edge portion 103e is different from that of the primary coil 101. In the example shown in FIG. 7B, end portions of the edge portion 103e are rounded. In an example shown in FIG. 7C, end portions of the edge portion 103e are tapered.

Thus, as has been described heretofore, according to this embodiment, the housing 103 which accommodates the primary coil 101 of the power transmission apparatus 100 projects vertically from the plane, and the size of the housing 103 when it is seen from thereabove is larger circumferentially by the first specified amount x1 in the four directions than the primary coil 101. In addition, the first specified amount x1 is the value which satisfies at least one of the conditions that the power transmission efficiency is equal to or greater than the threshold th1, and that the leakage magnetic field strength is smaller than the threshold th2 when the secondary coil 12 of the power reception apparatus 10 is included in the positional deviation permitting zone within the housing 103 when it is seen from thereabove, and the first specified amount x1 is the maximum amount (the positional deviation permitting amount) which permits the positional deviation of the secondary coil 12 relative to the primary coil 101. Due to this, with the electric vehicle 11 given such a tread (a distance between wheels) that a wheel thereof rides on the housing 103 in a case where the power receiving unit is not included in the housing 103 when it is seen from thereabove, in a case where the wheel rides on the housing 103, the driver of the electric vehicle 11 can sense from a loss of the balance of the electric vehicle 11 caused by the wheel riding on the housing 103 that the power transmission efficiency and the leakage magnetic field strength both do not satisfy the desired conditions due to the positional deviation of the electric vehicle 11 in the left-right direction. Since the housing 103 projects vertically from the plane, the driver of the electric vehicle 11 can grasp visually the target parking position. In this way, in parking the electric vehicle 11 in the parking position, the driver can accurately align the electric vehicle 11 in relation to the left-right direction through intuition. The electric vehicle 11 is aligned in relation to the front-rear direction by advancing or reversing the electric vehicle 11 until rear wheels Wrr, Wrl thereof come into contact with chocks 53 provided on the parking position.

Since the edge portion 103e which extends by the second specified amount x2 is provided at least part of the outer circumference of the housing 103, the driver of the electric vehicle 11 can grasp in advance the occurrence of a positional deviation from the fact that the wheel rides on the housing 103. When the second specified amount x2 which constitutes the radial dimension of the edge portion 103e is too great, even though an occurring positional deviation is small, the wheel of the electric vehicle 11 rides on the housing 103, whereas when the second specified amount x2 is too small, the driver cannot grasp the occurring positional deviation. Due to this, since the second specified amount x2 is equal to or smaller than 10 cm and is preferably of the order of 5 cm, the driver can grasp the occurring positional deviation in advance appropriately.

Since the vertical shape of the edge portion 103e differs from the shape of the primary coil 101, due to the improved visibility of the housing 103 from the shape thereof, the driver of the electric vehicle 11 can grasp visually the target parking position. In particular, when the end portions of the edge portion 103e are rounded or tapered, the wheel of the electric vehicle 11 easily rides on the housing 103, whereby the driver of the electric vehicle 11 can grasp in advance and accurately the occurrence of a positional deviation of the electric vehicle 11 which is triggered by the fact that the wheel rides on the housing 103.

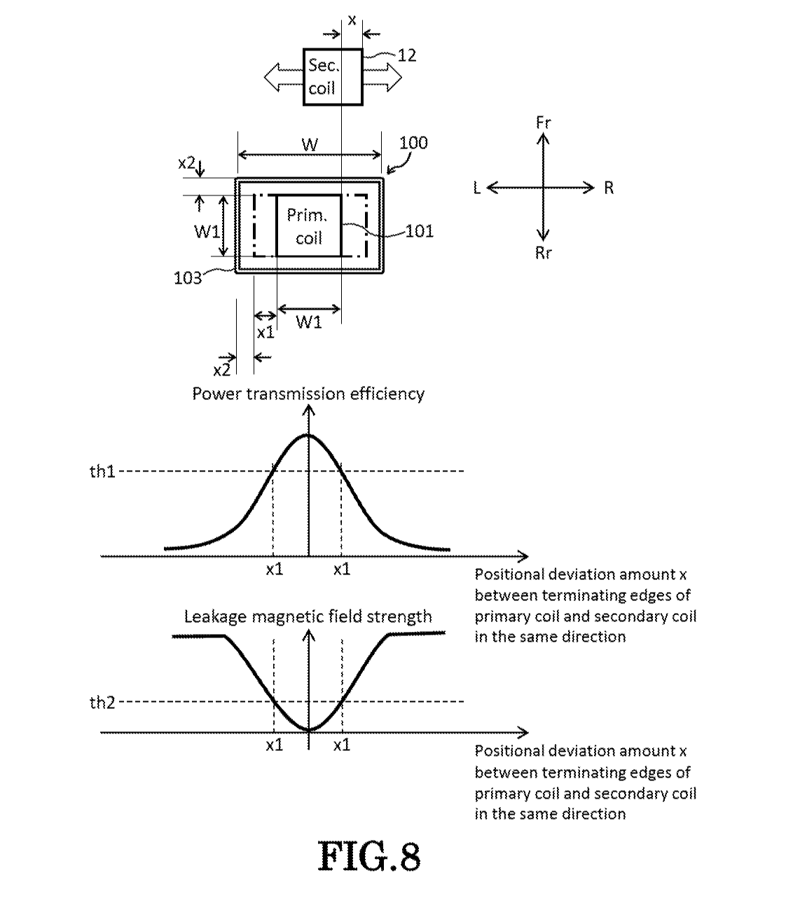

In the embodiment described heretofore, the horizontal terminating edges of the housing 103 are described as being expanded by the first specified amount xl or greater in the four directions (the front-rear direction and the left-right direction) from the primary coil 101. However, according to another embodiment, the expansion may be limited to the left-right direction as shown in FIG. 8. Horizontal terminating edges of a housing 103 are expanded further by a second specified amount x2 in the four directions or only in the left-right direction.

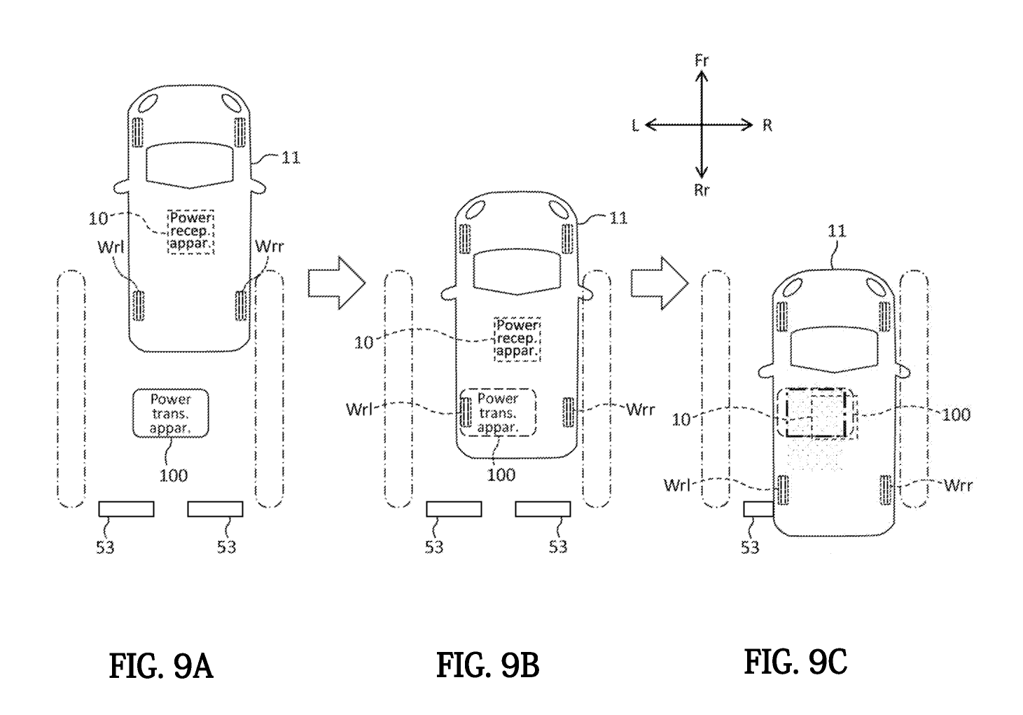

In this other embodiment, the housing 103 is made larger in the left-right direction than a primary coil 101 when it is seen from thereabove, and with an electric vehicle 11 given such a tread (a distance between wheels) that a wheel thereof rides on the housing 103 in a case where a secondary coil 12 is not included in a positional deviation permitting zone of the housing 103 in the left-right direction when it is seen from thereabove, when a wheel of the electric vehicle 11 rides on the housing 103 as shown in FIGS. 9A to 9C, a driver of the electric vehicle 11 can sense from a loss of the balance of the electric vehicle 11 caused by the wheel riding on the housing 103 that the power transmission efficiency and the leakage magnetic field strength both do not satisfy the desired conditions due to a positional deviation of the electric vehicle 11 in the left-right direction. An example shown in FIGS. 9A to 9C illustrates a case where in parking the electric vehicle 11 in a parking position, a left rear wheel Wrl rides on the housing 103 of a power transmission apparatus 100 since the electric vehicle 11 is parked so close to a right-hand side of the parking position as to surpass a positional deviation permitting amount. In this other embodiment, since the housing 103 is larger in size by “the first specified amount xl +the second specified amount x2” than the primary coil 101 only in the left-right direction, the housing 103 remains in size the same as the primary coil 101 in the front-rear direction. This makes it possible to provide the power transmission apparatus which is larger in size only in the left-right direction which the driver has difficulty in grasping.

The invention is not limited to the embodiments that have been described heretofore and hence can be modified or improved as required.

### DESCRIPTION OF REFERENCE NUMERALS AND CHARACTERS

10 Power reception apparatus
11 Electric vehicle
12 Secondary coil
51 Setting plane of power transmission apparatus
10 Power transmission apparatus
101 Primary coil
103 Housing
103e Edge portion
x1 First specified amount (Positional deviation permitting amount)
x2 Second specified amount
Wrr Right rear wheel
Wrl Left rear wheel

1. A power transmission apparatus, comprising:
a power transmitting unit which is disposed on a plane defined by a front-rear direction and a left-right direction which are at right angles to each other, and which transmits power in a non-contact manner to a power receiving unit installed in a vehicle which enables to move on the plane; and
a housing which accommodates the power transmitting unit, which is larger by a first specified amount in four directions than the power transmitting unit when the plane is seen from thereabove, and which projects vertically from the plane,
wherein in a case where the power receiving unit is positioned to be included in the housing when the plane is seen from thereabove, the first specified amount is a value which satisfies at least one of conditions that a power transmitting efficiency between the power transmitting unit and the power receiving unit is equal to or greater than a predetermined value, and that a leakage magnetic filed strength is smaller than a predetermined value.

2. The power transmission apparatus according to claim 1,
wherein when the plane is seen from thereabove, the housing has an edge portion which extends radially outwards by a second specified amount from at least part of an outer circumference which lies by the first specified amount away from an outer circumference of the power transmitting unit in four directions.

3. The power transmission apparatus according to claim 2,
wherein the second specified amount is equal to or smaller than 10 cm.

4. The power transmission apparatus according to claim 2,
wherein a vertical shape of the edge portion differs from a vertical shape of the power transmitting unit.

5. The power transmission apparatus according to claim 4,
wherein the edge portion is shaped that at least an end portion is rounded.

6. The power transmission apparatus according to claim 5,
wherein the edge portion is shaped that at least an end portion is tapered.

7. A power transmission apparatus, comprising:
a power transmitting unit which is disposed on a plane defined by a front-rear direction and a left-right direction which are at right angles to each other, which transmits power in a non-contact manner to a power receiving unit installed in a vehicle which enables to move on the plane; and
a housing which accommodates the power transmitting unit which is larger by a first specified amount in the left-right direction than the power transmitting unit when the plane is seen from thereabove, and which projects vertically from the plane,
wherein in a case where the power receiving unit is positioned to be included in the housing in the the left-right direction when the plane is seen from thereabove, the first specified amount is a value which enables to satisfy at least one of conditions that a power transmitting efficiency between the power transmitting unit and the power receiving unit is equal to or greater than a predetermined value, and that a leakage magnetic filed strength is smaller than a predetermined value, and
the left-right direction is a direction which is substantially at right angles to a traveling direction of the vehicle while following the plane.

8. The power transmission apparatus according to claim 7,
wherein when the plane is seen from thereabove, the housing has an edge portion which extends radially outwards by a second specified amount from at least part of left and right outer circumferences of the housing which lie by the first specified amount away from an outer circumference of the power transmitting unit in the left-right direction direction, and front and rear outer circumferences of the power transmitting unit in the front-rear direction.

9. The power transmission apparatus according to claim 7,
wherein when the plane is seen from thereabove, the housing has an edge portion which extends radially outwards by a second specified amount from left and right outer circumferences of the housing which lie by the first specified amount away from an outer circumference of the power transmitting unit in the left-right direction.
